(19) United States
(12) Patent Application Publication
(10) Pub. No.: US 2020/0391628 A1
(43) Pub. Date: Dec. 17, 2020

(54) Retractable Middle Car Seat Cushion

(71) Applicant: Charles Patrick Doherty, Worth, IL (US)

(72) Inventor: Charles Patrick Doherty, Worth, IL (US)

(21) Appl. No.: 16/835,590

(22) Filed: Mar. 31, 2020

Related U.S. Application Data
(60) Provisional application No. 62/921,372, filed on Jun. 13, 2019.

(51) Int. Cl. B60N 2/36; B60N 3/00

(52) U.S. Cl. CPC B60N 2/36; B60N 3/002

(57) ABSTRACT

A front driver and passenger bucket car seat is provided. The middle seat cushion of both the front driver and passenger bucket seats can be detachable to retrieve or store objects from the car floor. The middle seat cushion of a front car seat can be flipped up for easy cleaning of the floor of the car under the front seats.

### FIELD

The present application refers to a seat cushion that is retractable from its anchored seat.

### BACKGROUND

In the car industry, car seats are properly set to adjust to the size of the person preparing to drive the car. They are not set to retrieve any items that are dropped underneath the bucket seats. It can be very difficult to retrieve these items as it is hard to kneel down on the ground and reach under the seat to obtain lost items. Also, another use for the retractable car seat is to store items that can't fit into the glove compartment. A final use for the retractable car seat is easy access for cleaning underneath the front two car seats.

### SUMMARY

By providing a seat cushion that can be flipped up, the retrieving of items lost or dropped underneath the seat can be made much less difficult.

By making a modification of a car seat this can be achieved.

While the whole seat can remain attached to the manual seat tract the seat cushion would have a separate hinge that would allow the middle seat cushion to flip open. Retracting the seat cushion would allow the driver or passenger to easily retrieve items from the car floor, i.e. keys, loose change, credit cards etc.

Another function of the retractable car seat would be to store or hide items that can't fit in a glove box, i.e. laptops, i-pads, clothing etc.

A final function of the retractable car seat would be the ability to flip-up the middle car seat cushion for easy cleaning underneath the two front bucket car seats.

The function of this seat cushion will become apparent from the detailed description.

### BRIEF DESCRIPTION OF THE DRAWINGS

FIG. 1 is the top view of the first embodiment.

FIG. 2 is the side view of the embodiment.

FIG. 3 is the front view of the embodiment.

### DETAILED DESCRIPTION

In the following detailed description, the interior design according to the instructions for this application in the form of a front driver/passenger standard bucket car seat will be described by the embodiments.

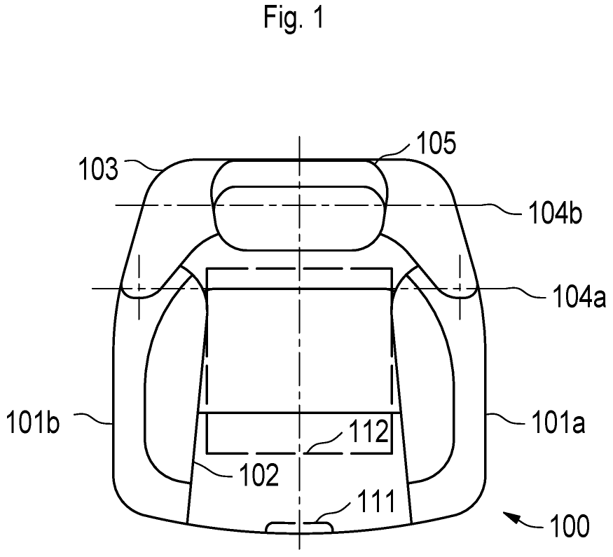

The first embodiment of the retractable car seat 100 is illustrated in FIG. 1. The retractable car seat 100 includes a left side cushion 101a with a right side cushion 101b, a middle seat cushion 102, the back seat 103, the middle seat cushion rolling hinge 104a, and the back seat cushion rolling hinge 104b. On the front of the middle seat cushion is the lift handle 111. Also on the floor of the car sits the tray 112. In the present embodiment of the middle seat cushion 102 has attached to it middle seat cushion rolling hinge 104a. The embodiment of back seat 103 has attached to it back seat rolling hinge 104b.

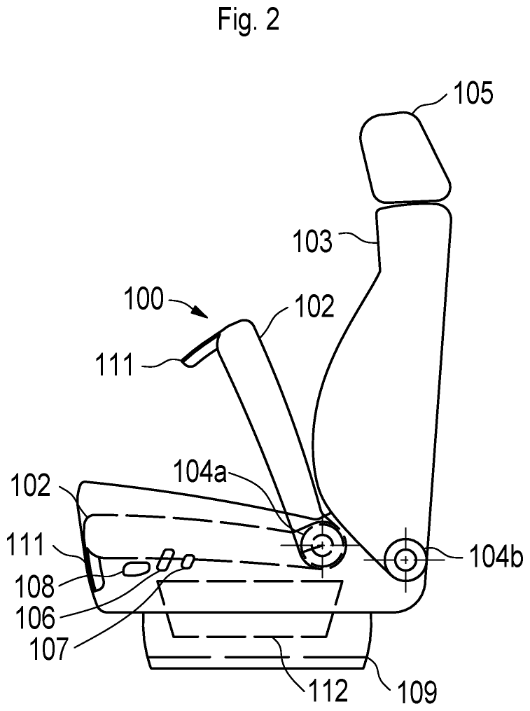

The embodiment of the retractable car seat 100 is illustrated in FIG. 2. In the present embodiment of side view 100 is head rest 105, back seat 103, back seat rolling hinge 104b, middle seat rolling hinge 104a, and middle seat cushion 102. Also included in the present embodiment of side view 100 is the car seat cushion up and down lever 106, the back seat adjustment back and forth lever 107, seat tract forward lever 108, and front seat tract 109. The lift handle 111 and tray 112 are shown in the side view.

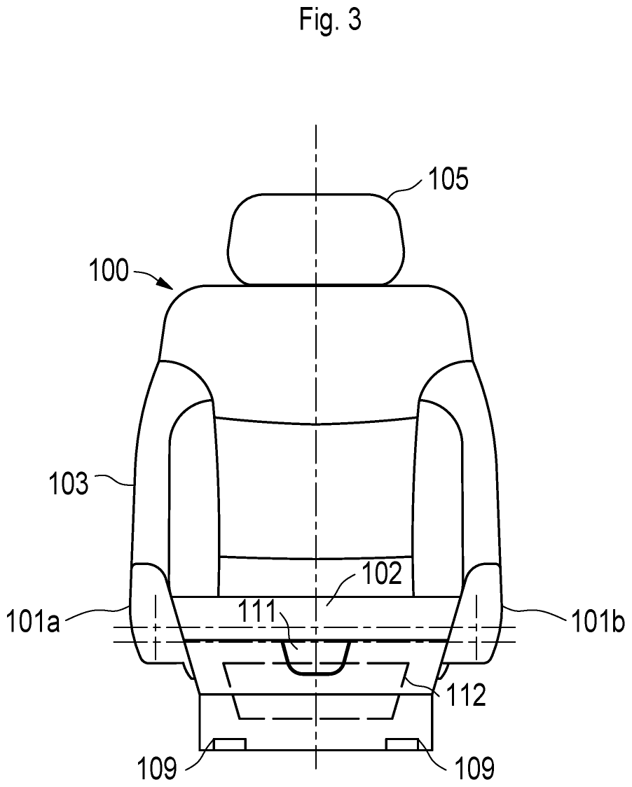

The embodiment of the retractable car seat 100 is illustrated in FIG. 3. The retractable car seat 100 front view according to the embodiment has all the same components as the first embodiment in FIG. 1.

Although such details can differ from car manufacturer to car manufacturer, the basics of the retractable car seat can be applicable to any car seat made by any manufacturer.

Further, the retractable car seat can also be applied to sport utility vehicles and pick-up trucks with bucket seats.

While endeavoring in the foregoing specification to draw attention to these features of the invention believed to be of particular importance it should be understood that the applicant claims protection in respect of any patentable feature or combination of features herein before referred to and/or shown in the drawings whether or not particular emphasis has been placed thereon.

1. In the interior of a car where part of the front driver and passenger bucket seat can be detachable from the main frame of the seats.

2. A car seat according to claim 1, wherein the middle seat cushion becomes detached from the side cushions and the seat tracks that can be lifted up separately from the main frame of the car seat.

3. A car seat according to claim 2, wherein the middle seat cushion becomes attached to the middle seat rolling hinge allowing the middle seat cushion to lift up and down.

4. A car seat according to claim 3, wherein the middle seat cushion is attached to the middle seat cushion lift handle allowing a human hand to grip the handle to lift the cushion up or down.
A car seat according to claim 4, wherein a tray sits on the floor of the car to set stored items on.
